(19) United States
(12) Patent Application Publication
(10) Pub. No.: US 2020/0047089 A1
(43) Pub. Date: Feb. 13, 2020

(54) MODULAR FLOWBACK FILTER SYSTEM

(71) Applicant: FMC Technologies, Inc., Houston, TX (US)

(72) Inventors: James Cook, Granbury, TX (US); Julian Keihany, Houston, TX (US); Jason Mannen, Kingwood, TX (US); Sergio Arreola, Jr., Pearland, TX (US); Kelly P. Ciprick, Englewood, CO (US)

(21) Appl. No.: 16/496,210

(22) PCT Filed: Mar. 22, 2018
(86) PCT No.: PCT/US18/23737

§ 371 Date: Sep. 20, 2019

Related U.S. Application Data
(60) Provisional application No. 62/476,023, filed on Mar. 24, 2017.

(51) Int. Cl. B01D 29/35; B01D 29/52

(52) U.S. Cl. CPC B01D 29/35; B01D 35/12; B01D 29/52

(57) ABSTRACT

A flowback filter system includes a system inlet, a system outlet, a filter vessel that includes a removable filter insert, an inlet control valve that provides selective fluid communication between the system inlet and the filter vessel, an outlet control valve that provides selective fluid communication between the filter vessel and the system outlet, and a first access platform is positioned proximate the inlet and outlet control valves, wherein the inlet and outlet control valves are positioned for access from the first access platform at one or more ergonomically appropriate heights relative to an upper surface of the first access platform.

### BACKGROUND

### 1. Field of the Disclosure

The present subject matter is generally directed to systems that are used for drilling and completing wellbores, and in particular, to equipment and systems that are used for removing debris from flowback fluids that are returned from drilled wellbores.

### 2. Description of the Related Art

During a typical hydraulic fracturing operation, fracturing fluids are pumped down a well to fracture a hydrocarbon bearing formation. The fracturing fluids, along with other fluids from the formation, then flow out of the well into what is commonly referred to as “flowback equipment” for containment, treatment, processing, etc. The “flowback fluid” flowing out of the well may often contain unwanted debris, such as particulates from the drilling process and remnants of frac balls and/or other disposable elements that are used during the fracturing operation. This unwanted debris can, in certain circumstances, damage or otherwise negatively affect the functionality of the flowback equipment. To reduce the adverse effects of any such debris that flows back from the well with the flowback fluid, a piece of equipment commonly referred to as a “junk catcher” is typically positioned in the fluid pathway between the wellhead and other flowback equipment so as to capture the entrained debris. However, some prior art junk catchers can be problematic for on-site personnel to safely operate and maintain.

The following disclosure is directed to various novel and improved systems and equipment that may be used to remove debris from flowback fluids that are returned from a drilled wellbore during certain drilling and/or completion operations, such as during wellbore fracturing operations and the like.

### SUMMARY OF THE DISCLOSURE

The following presents a simplified summary of the present disclosure in order to provide a basic understanding of some aspects disclosed herein. This summary is not an exhaustive overview of the disclosure, nor is it intended to identify key or critical elements of the subject matter disclosed here. Its sole purpose is to present some concepts in a simplified form as a prelude to the more detailed description that is discussed later.

Generally, the subject matter disclosed herein is directed to systems and equipment that may be used for removing debris from flowback fluids that are returned from drilled wellbores during certain drilling or completion operations, such hydraulic fracturing operations and the like. In one illustrative embodiment, an exemplary flowback filter system is disclosed that includes, among other things, a system inlet, a system outlet, and a filter vessel that includes a removable filter insert. The illustrative flowback filter system also includes an inlet control valve that provides selective fluid communication between the system inlet and the filter vessel, an outlet control valve that provides selective fluid communication between the filter vessel and the system outlet, and a first access platform that is positioned proximate the inlet and outlet control valves, wherein the inlet and outlet control valves are positioned for access from the first access platform at one or more ergonomically appropriate heights relative to an upper surface of the first access platform.

In another exemplary embodiment of the present disclosure, an illustrative filter vessel includes a filter housing defining an inner bore and a removable filter insert positioned in the inner bore. The filter housing includes, among other things, a flow inlet in the filter housing, a flow outlet in the filter housing, and a removable portion that provides access to the inner bore, wherein the flow inlet and flow outlet are in fluid communication with the inner bore. Additionally, the removable filter insert includes a seal that engages with and seals against an inner surface of the inner bore of the filter housing between the flow inlet and the flow outlet.

Also disclosed herein is an illustrative flowback filter system that includes a system inlet, a system outlet, a plurality of filter vessels, a plurality of inlet control valves that provide selective fluid communication between the system inlet and one or more of the plurality of filter vessels, and a plurality of outlet control valves that provide selective fluid communication between the system outlet and one or more of the plurality of filter vessels. Additionally, the disclosed flowback filter system further includes at least one access platform that is positioned proximate the pluralities of inlet and outlet control valves and proximate the plurality of filter vessels, wherein each of the plurality of inlet and outlet control valves and each of the plurality of filter vessels are positioned for access from the at least one access platform at one or more ergonomically appropriate heights relative to an upper surface of the at least one access platform.

### BRIEF DESCRIPTION OF THE DRAWINGS

The disclosure may be understood by reference to the following description taken in conjunction with the accompanying drawings, in which like reference numerals identify like elements, and in which:

FIG. 1 is a perspective view of a flowback filter system according to an exemplary embodiment of the present disclosure;

FIG. 2 is a cross-sectional perspective view depicting an exemplary filter vessel in accordance with certain illustrative embodiments of the present disclosure;

FIG. 2A is a cross-sectional view of an illustrative filter insert seal in accordance with some exemplary embodiments of the filter vessel disclosed herein; and

FIG. 3 is a perspective view of an exemplary flowback filter system disclosed herein showing the positional relationships between the various elements of the flowback filter system and associated access platforms.

While the subject matter disclosed herein is susceptible to various modifications and alternative forms, specific embodiments thereof have been shown by way of example in the drawings and are herein described in detail. It should be understood, however, that the description herein of specific embodiments is not intended to limit the subject matter defined by the appended claims to the particular forms disclosed, but on the contrary, the intention is to cover all modifications, equivalents, and alternatives falling within the spirit and scope of the claimed subject matter.

### DETAILED DESCRIPTION

Various illustrative embodiments of the presently disclosed subject matter are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present subject matter will now be described with reference to the attached figures. Various systems, structures and devices may be schematically depicted in the drawings for purposes of explanation only and so as to not obscure the present disclosure with details that are well known to those skilled in the art. Nevertheless, the attached drawings are included to describe and explain illustrative examples of the present disclosure. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

As used in this description and in the appended claims, the terms “substantial” or “substantially” are intended to conform to the ordinary dictionary definition of that term, meaning “largely but not wholly that which is specified.” As such, no geometrical or mathematical precision is intended by the use of terms such as “substantially flat,” “substantially perpendicular,” “substantially parallel,” “substantially circular,” “substantially elliptical,” “substantially rectangular,” “substantially square,” “substantially aligned,” and/or “substantially flush,” and the like. Instead, the terms “substantial” or “substantially” are used in the sense that the described or claimed component or surface configuration, position, or orientation is intended to be manufactured, positioned, or oriented in such a configuration as a target. For example, the terms “substantial” or “substantially” should be interpreted to include components and surfaces that are manufactured, positioned, or oriented as close as is reasonably and customarily practicable within normally accepted tolerances for components of the type that are described and/or claimed. Furthermore, the use of phrases such as “substantially conform” or “substantially conforms” when describing the configuration or shape of a particular component or surface, such as by stating that “the configuration of the component substantially conforms to the configuration of a rectangular prism,” should be interpreted in similar fashion.

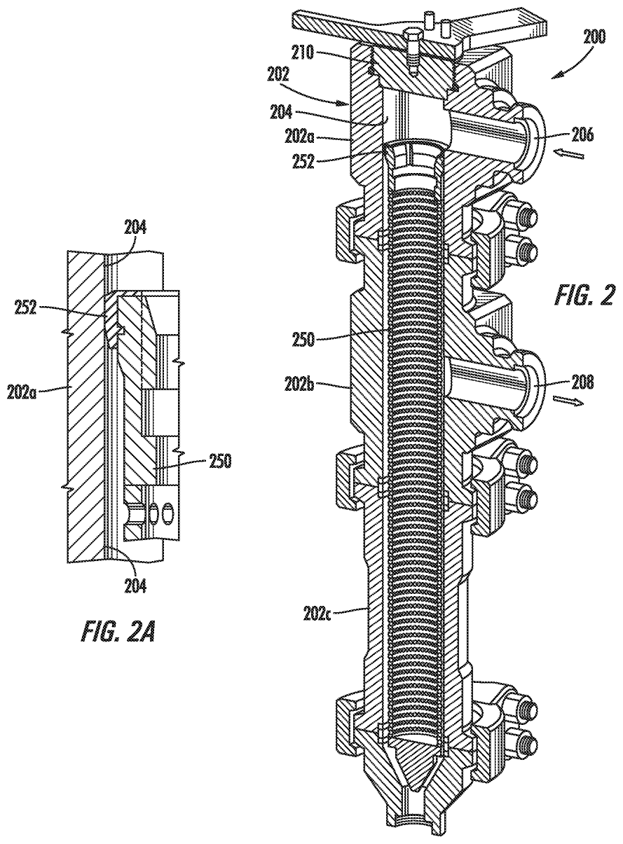

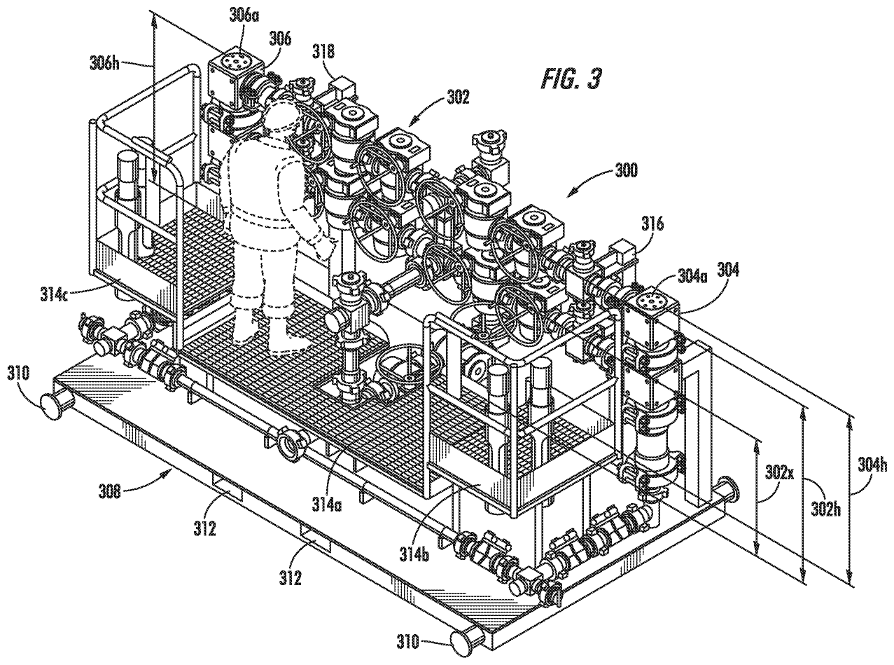

Furthermore, it should be understood that, unless otherwise specifically indicated, any relative positional or directional terms that may be used in the descriptions set forth below —such as “upper,” “lower,” “above,” “below,” “over,” “under,” “top,” “bottom,” “vertical,” “horizontal,” “lateral,” and the like have been included so as to provide additional clarity to the description and the appended claims, and should be construed in light of that term's normal and everyday meaning relative to the depiction of the components or elements in the referenced figures. For example, referring to the perspective view of the flowback filter system 300 depicted in FIG. 3, it should be understood that the main access platform 314a is depicted as being substantially “horizontally” oriented and positioned “above” the base structure 308. Additionally, the secondary access platforms 314b and 314c are shown in FIG. 3 as being positioned “laterally” adjacent to opposite ends of the main access platform 314a, and the “top” or “upper” surface of each of the secondary access platforms 314b and 314c is depicted as being positioned at a height level “above” the base structure 308 that is greater than the height level of the main access platform 314a “above” the base structure 308.

Generally, the subject matter disclosed herein is directed to improved systems and equipment that may be used to remove debris from flowback fluids that are returned from a wellbore during drilling and/or completion operations. For example, a flowback filter system in accordance with various embodiments of the present disclosure provides the functionality of a “junk catcher” in a manner that is substantially easier for on-site personnel to operate and maintain, and in certain instances safer to operate and maintain, than flowback filter systems know in the in art. In certain embodiments, the flowback filter system may be characterized by redundant, modular filter vessels that are substantially vertically oriented and fed through one or more control valves. Additionally, in at least some embodiments disclosed herein, the control valves may be ergonomically positioned for ease of operation by on-site personnel with respect to access platforms that are positioned adjacent to and/or surrounding the flowback filter system. Such system configurations may reduce, and in some instances eliminate, situations wherein it is necessary for personnel to perform activities and operations that might be outside of the most ergonomically efficient work areas, such as to actuate valves, or to move, reach, or step over equipment components such as pipes and/or valves and the like. It may also provide for easier maintenance and replacement of debris filters, thereby improving the overall efficiency of the flowback operation.

As will be readily apparent to the ordinarily skilled artisan upon a complete reading of the present disclosure, the various concepts, equipment, and systems described herein may be used in conjunction with substantially any type of wellbore drilling and/or completion application in which debris-bearing fluids are returned from the wellbore, such as, for example, during wellbore fracturing operations and the like. Accordingly, it should be understood that the subject matter of the present disclosure may be readily adapted for other similar applications know to those having skill in the relevant art. With reference to the attached figures, various illustrative embodiments of the systems and equipment disclosed herein will now be described in more detail.

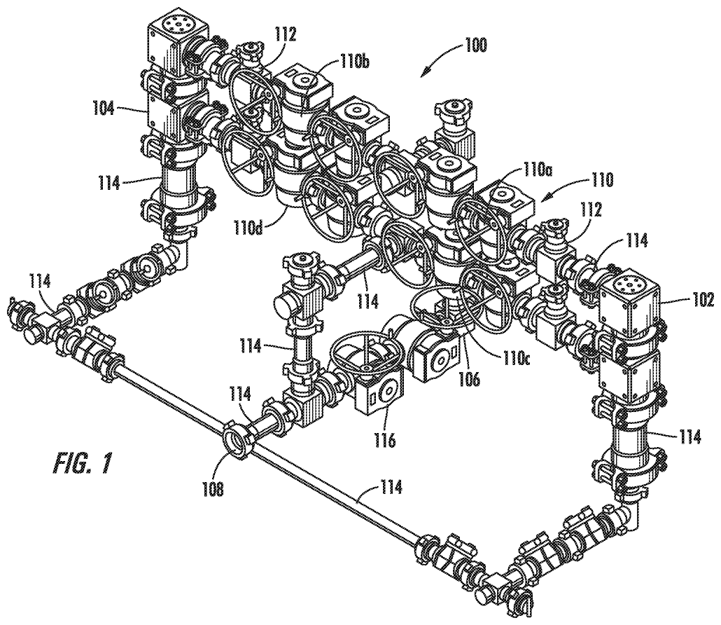

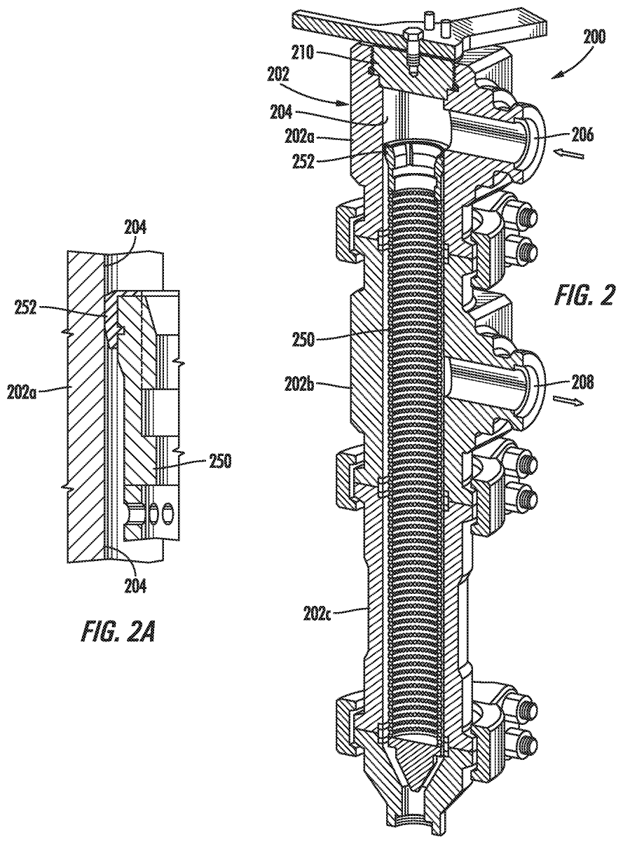

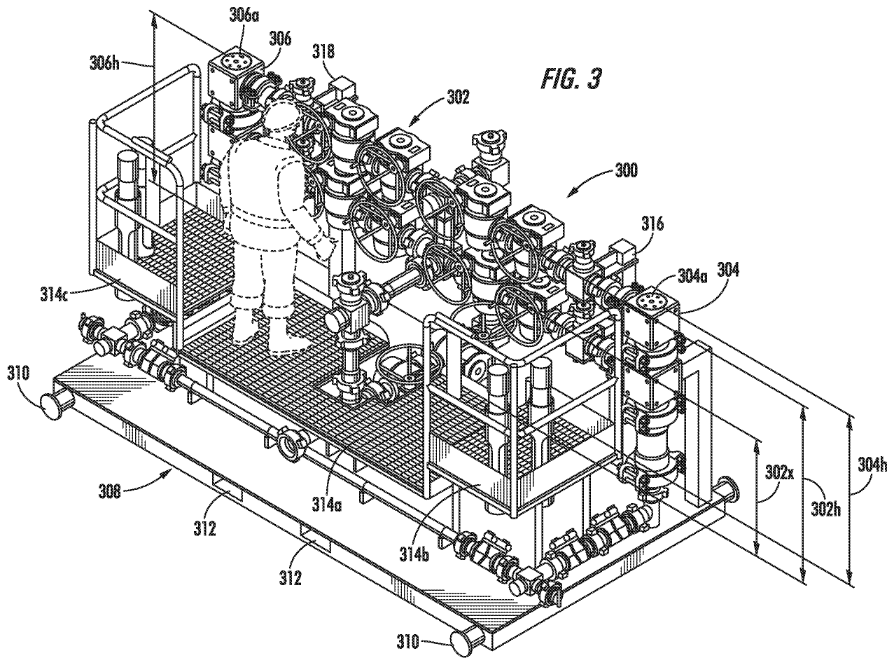

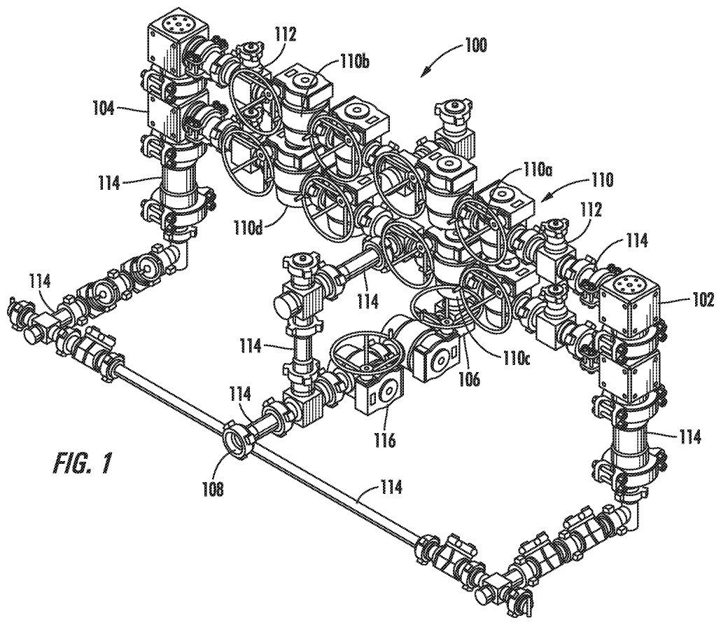

FIG. 1 shows one example of a flowback filter system 100 according to certain illustrative aspects of the present disclosure. The flowback filter system 100 may include multiple filter vessels 102 and 104 that are substantially vertically oriented, each of which may contain a removable filter insert, as will be further described in conjunction with FIG. 2 below. The substantially vertically-oriented filter vessels 102 and 104 may be in fluid communication with a system inlet 106 and a system outlet 108 through a plurality of control valves 110, tool access points 112, pipe segments 114, and other fluid conduits. Some or all the elements of the flowback filter system 100, including the filter vessels 102 and 104, the control valves 110, the tool access points 112, and the pipe segments 114, may include modular elements that are coupled together by way of speed connectors, flanges, or other connectors that would be appreciated by one of ordinary skill in the art in view of this disclosure. As illustrated in FIG. 1, the elements of the flowback filter system 100 may be connected using clamp-type connections, such as Grayloc® clamp connectors and the like, although it should be appreciated that other types of connectors, such as flanges, threaded fittings, etc., may also be used. The order and number of control valves 110, tool access points 112, pipe segments 114, and other fluid conduits and components may vary depending upon the particular application, and are not otherwise limited to the number and type of components shown in the embodiment depicted in FIG. 1.

In certain embodiments, the plurality of control valves 110 may include one or more inlet control valves 110a and one or more inlet control valves 110b that are adapted to provide selective communication between the system inlet 106 and the filter vessels 102 and 104, respectively. The plurality of control valves 110 may further include one or more outlet control valves 110c and one or more outlet control valves 110d that are adapted to provide selective communication between the system outlet 108 and the filter vessels 102 and 104, respectively. In at least some exemplary embodiments, the flowback filter system 100 may further include one or more bypass valves 116 that allow the system inlet 106 to be in fluid communication with the system outlet 108 without the flow passing through either or both of the intermediate filter vessels 102 and 104.

In use, the flowback filter system 100 may be connected to a wellhead (not shown) via the system inlet 106 and to other flowback equipment via the system outlet 108, and fluid from the wellhead may flow from the system inlet 106 to the inlet control valves 110a and 110b by way of one or more pipe segments 114. Once arriving at the inlet control valves 110a and 110b, the fluid can then be directed to one or both of the filter vessels 102 and 104 by opening the associated inlet control valve 110a and/or 110b. Furthermore, as the fluid passes through the filter vessels 102 and 104, debris within the fluid may be captured, and the filtered fluids may pass to the system outlet 108 through the outlet control valves 110c and 110d and through one or more pipe segments 114.

In some embodiments, the inlet control valves 110a and 110b and the outlet control valves 110c and 110d may be operated in such a manner so as to completely isolate one of the filter vessels 102 and 104 from the fluid flow while still flowing fluid through the other of the two filter vessels. By way of example only and not by way of limitation, in order to flow the fluid from the wellhead through the filter vessel 102 and isolate the filter vessel 104 from the flow, the inlet control valves 110a and outlet control valves 110c may be opened, and the inlet control valves 110b and the outlet control valves 110d may be closed. Conversely, in order to flow the fluid from the wellhead through the filter vessel 104 and isolate the filter vessel 102 from the flow, the inlet control valves 110a and the outlet control valves 110c may be closed, and the inlet control valves 110b and the outlet control valves 110d may be opened. This redundant filter vessel and control valve arrangement may therefore allow for maintenance to be performed safely on one of the filter vessels 102 or 104 while still allowing operations of the flowback filter system 100 to continue by directing the flow from the wellhead through the other of the two filter vessels.

FIG. 2 shows one embodiment of an exemplary filter vessel 200 according to certain illustrative aspects of the present disclosure. For example, in some embodiments, the filter vessel 200 may be used as one or more of the filter vessels 102 and 104 shown in FIG. 1. As shown in FIG. 2, the filter vessel 200 may include a removable filter insert 250 positioned within an outer filter housing 202. In certain embodiments, the filter housing 202 may have an elongated structure that defines an inner bore 204 in which the removable filter insert 250 may be positioned. The filter housing 202 may also include a flow inlet 206 and a flow outlet 208 that provide fluid communication with the inner bore 204, and a removable portion 210 that provides access to the inner bore 204 for removal and replacement of the removable filter insert 250.

As depicted in FIG. 2, the elongated structure of the filter housing 202 is provided by one or more separated elements 202a-c that are coupled together by appropriately designed connectors, such as Grayloc® clamp-type connectors and the like, to define the inner bore 204. This configuration allows for modularity and consequent easy manufacturing, repair, and/or replacement of the structural elements 202a-c, as well as easy modification of the filter housing 202 so as to meet the needs of a particular hydraulic fracturing project. However, it should be understand after a complete reading of the present disclosure that such a multiple-part configuration for the filter housing 202 is not required for all applications, and as such the multiple-part configuration depicted in FIG. 2 should not be considered as limiting to the scope of the disclosed subject matter. For instance, in other exemplary embodiments the filter housing 202 may be a single, integrated structure, or the elements 202a-c may be connected by way of other types of connections, such as flanges and the like.

As depicted, the removable portion 210 may include a cap that is adapted to be threadably engaged with the top of the filter housing 202. In such embodiments, when it becomes necessary to remove the removable filter insert 250, the cap can be unthreaded and removed from the filter housing 202, thereby allowing access to the inner bore 204 and the removable filter insert 250 through the open top of the filter housing 202. Furthermore, this configuration may allow for easy removal of the removable filter insert 250 when the filter vessel 200 is in a substantially vertically oriented arrangement, as is shown in FIG. 2. It should be appreciated, however, that the removable portion 210 is not limited to placement at the top of the filter housing 202, as placement of the removable portion 210 may be modified depending on the desired orientation of the filter vessel 200 so as to assure easy access for removal and/or replacement of the removable filter insert 250. Additionally, the removable portion 210 is not solely limited to the cap configuration and threaded engagement arrangement illustrated in FIG. 2, as other vessel end closures known in the art may also be used.

The removable filter insert 250 may have an elongated tubular structure that is sized to fit within the inner bore 204 of the filter housing 202. As depicted in FIG. 2, fluid communication is provided between the inside and the outside of the tubular structure by way of a plurality of openings through the tubular structure that are sized to prevent passage of debris. In certain illustrative embodiments, the plurality of openings through the tubular structure of the removable filter insert 250 may be regularly sized and spaced, as shown in FIG. 2. However, it should be also appreciated by those of ordinary skill that the spacing, size, shape, and orientation of the openings are not limited to the opening arrangement depicted embodiment. Moreover, in some exemplary embodiments, the removable filter insert 250 may be rotationally independent with respect to the filter housing 202, so that clocking is not required.

With continuing reference to FIG. 2, the removable filter insert 250 may in certain embodiments include a seal 252 that engages with the surface defining the inner bore 204 of the filter housing 202, and which is energized when the removable filter insert 250 is positioned within the inner bore 204. The seal 252 may be an abrasion resistant, non-metal material that engages with the metal material of the filter housing 202, thereby preventing metal-to-metal contact between the removable filter insert 250 (which may also be made of a metal material) and the filter housing 202. As shown in FIG. 2, the seal 252 may be positioned at or near a top end of the removable filter insert 250 so that it seals the bore 204 between the flow inlet 206 and the flow outlet 208 when the removable filter insert 250 is fully installed. FIG. 2A shows a cross-sectional view of one exemplary configuration of seal 252 that may be used in conjunction with certain illustrative embodiments of the filter vessel 200 and filter insert 250, although it should be understood that other seal configurations may also be used.

In the embodiment depicted in FIG. 2, the removable filter insert 250 may be fully installed when it rests at the bottom of the filter housing 202, such that the lower end of the removable filter insert 250 is in contact with and supported by the lower end of the filter housing 202, thereby minimizing the potential for damaging the removable filter insert 250. When the filter vessel 200 is configured in this manner, the fluid flow from the wellhead is prevented from passing from the flow inlet 206 to the flow outlet 208 without first passing through the removable filter insert 250, thus trapping debris that is entrained in the fluid flow within the removable filter insert 250. It should be appreciated by those of ordinary skill after a complete reading of the present disclosure that the configurations of the removable filter insert 250 and the seal 252 are not limited to the particular embodiment depicted in FIG. 2, and may be modified depending on the application, the configuration of the filter housing 202, and/or the associated flowback filter system.

In use, the filter vessel 200 may be connected to a flowback filter system, such as the flowback filter system 100 depicted in FIG. 1, via the flow inlet 206 and the flow outlet 208. As the filter vessel 200 receives fluid from the wellbore through the flow inlet 206, that fluid must pass into and through the removable filter insert 250 before reaching the flow outlet 208. Debris within the fluid will be prevented from passing through the openings in the removable filter insert 250 and thereby become captured and contained within the removable filter insert 250. Flow from the wellbore may continue in this fashion until the removable filter insert 250 becomes full of debris, or contains enough debris such that flow through the filter vessel 200 is sufficiently restricted. At that time, flow through the filter vessel 200 then may be stopped in the manner described with respect to the flowback filter system 100 described above so that the removable filter insert 250 can be removed from the bore 204, such as by removing the removable portion 210, e.g., a threaded cap. Thereafter, the removable filter insert 250 may be cleaned and reinstalled within the bore 204, or replaced by a new removable filter insert as may be warranted.

FIG. 3 shows an illustrative flowback filter system 300 in accordance with additional exemplary aspects of the present disclosure. As depicted in FIG. 3, the flowback filter system 300 may include a plurality of control valves 302, filter vessels 304 and 306, and various other elements that are deployed on a base structure 308. In some embodiments, the various components of the flowback filter system 300 may be arranged similarly to the valves, flow elements, and vessels described with reference to FIG. 1 and FIG. 2 above. In the particular embodiment shown in FIG. 3, the filter vessels 304 and 306 may be substantially vertically oriented, i.e., such that they extend in a substantially vertical direction from the base structure 308. Additionally, the plurality of control valves 302 may be positioned a distance above the base structure 308 and arranged in two stacked horizontal rows between the filter vessel 304 and the filter vessel 306. In certain embodiments, the base structure 308 may be configured as, for example, a movable metal structure, such as a skid, that is deployable using crane connection points 310 or fork lift slots 312. In other embodiments, the base structure 308 may be part of a trailer, or it may be removably or fixedly attached to a trailer.

As shown in FIG. 3, one or more raised access platforms 314a-c may be attached to the base structure 308 so as to provide access to one or more of the plurality of control valves 302, the filter vessels 304 and 306, and other system elements by on-site personnel. As is shown in in FIG. 3, a main access platform 314a may be appropriately positioned so as to provide an access and egress point to and from the flowback filter system 300 for personnel, as well as to provide a working surface on which personnel can stand while operating, repairing, or maintaining the flowback filter system 300. For example, in certain exemplary embodiments, the main access platform 314a may be positioned proximate the plurality of control valves 302 so that personnel can readily actuate one or more of the control valves 302, as will be further described below.

Additionally, one or more secondary access platforms 314b and 314c may be positioned such that they are readily accessible from the main access platform 314a. In some embodiments, the secondary access platforms 314b and 314c may be positioned laterally adjacent to the main access platform 314a so as to provide access to the filter vessels 304 and 306. Furthermore, and depending on the position, size, and orientation of the filter vessels 304 and 306, the secondary access platforms 314b and 314c may be positioned at a different height level above the base structure 308 than that of the main access platform 314a. In particular, the secondary access platforms 314b and 314c may be positioned so as to provide ready access to the removable portions 304a and 306a of the filter vessels 304 and 306, thus allowing on-site personnel to remove the removable portions 304a and/or 306a so as to access the inner bores and removable filter inserts of the filter vessels 304 and 306 from the secondary access platforms 314b and 314c when repair and/or maintenance operations are required. As will be appreciated by the ordinarily skilled artisan after a complete reading of the present disclosure, the number, shape, size, and arrangement of the main and secondary access platforms is not limited to those depicted in FIG. 3, and may depend on the particular layout of the flowback filter system 300, including the quantities, sizes, and locations of system components such as control valves and filter vessels.

In at least some embodiments, the handles/actuators for some or all the plurality of control valves 302 may be arranged so that they are easily accessible to personnel standing on the main access platform 314a. As is depicted in the embodiment shown in FIG. 3, the handles/actuators for the control valves 302 may all be oriented in substantially the same direction, i.e., toward the main access platform 314a, so that each can be manipulated from the main access platform 314a substantially without necessitating unnecessary effort or difficulty, such as by bending, squatting, and/or reaching, by operating personnel standing on the main access platform 314a. Additionally, control valves 302 may be positioned in work areas and at heights that are ergonomically appropriate for personnel standing on the main access platform 314a while operating the equipment. As used herein and in the appended claims, the term “ergonomically appropriate” should be understood to mean work areas, heights, or positions that provide optimal efficiency and comfort for personnel in the working environment when interacting with and/or operating the equipment.

For example, the position of the main access platform 314a relative to the positions of the handles/actuators of the control valves 302 may be selected so that the centerlines of the handles/actuators of the upper and lower rows of control valves 302 are at an ergonomically appropriate height 302h (upper row) and 302x (lower row) relative to the height level of the main access platform 314a. In certain embodiments, an “ergonomically appropriate height” may be predetermined such that the handles/actuators of the control valves 302 are positioned at height levels above the surface of the main access platform 314a which places them between the waist and shoulders of an average-sized person standing on the main access platform 314a. For example, in some illustrative embodiments, the centerline height 302h of the handles/actuators on the upper row of control valves 302 may be in the range of approximately 1.12 m to 1.27 m (44″ to 50″) above the surface of the main access platform, such as about 1.20 m (47″). In other embodiments, the centerline height 302x of the handles/actuators on the lower row of control valves 302 may be in the range of approximately 0.69 m to 0.84 m (27″ to 33″) above the surface of the main access platform, such as about 0.76 m (30″).

Similarly, the positions of the secondary access platforms 314b and 314c may also be selected so that the removable portions 304a and 306a of the filter vessels 304 and 306 are positioned within ergonomically appropriate work areas relative to the height levels and lateral proximity of the secondary access platforms 314b and 314c. For example, in certain embodiments the upper surfaces of the filter vessels 304/306 may be positioned at heights 304h/306h above the upper surfaces of the respective secondary access platforms 314b/314c that range from approximately 0.79 m to 0.97 m (31″ to 38″), such as about 0.88 m (34.5″).

In at least some embodiments, the flowback filter system 300 may also include one of more lift features that allow for elements of the flowback filter system 300 to be removed from, or installed in, the filter vessels 304 and/or 306 during maintenance operations. For example, in the embodiment depicted in FIG. 3, the lift features may include lift points 316 and 318 that provide locations where a lifting apparatus, such as a jib crane and the like, can be connected to a structural element of the flowback filter system 300 and used to remove removable filter inserts from or install removable filter inserts into the filter vessels 304 and/or 306, or to remove portions of the filter vessels 304 and 306 for repair, maintenance, or replacement. Furthermore, additional lift features may also be incorporated in other areas of the flowback filter system 300 so that similar lifting, repair, maintenance, or replacement operations can also be performed on other equipment components of the system 300.

The particular embodiments disclosed above are illustrative only, as the subject matter defined by the appended claims may be modified and practiced in different but equivalent manners apparent to those skilled in the art having the benefit of the teachings herein. For example, some or all of the operation steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the claimed subject matter. Note that the use of terms, such as “first,” “second,” “third,” or “fourth” to describe various operations or structures in this specification and in the attached claims is only used as a shorthand reference to such steps/structures and does not necessarily imply that such steps/structures are performed/formed in that ordered sequence. Of course, depending upon the exact claim language, an ordered sequence of such processes may or may not be required. Accordingly, the protection sought herein is as set forth in the appended claims set forth below.

1. A flowback filter system, comprising:
a system inlet;
a system outlet;
a filter vessel comprising a removable filter insert;
an inlet control valve providing selective fluid communication between the system inlet and the filter vessel;
an outlet control valve providing selective fluid communication between the filter vessel and the system outlet; and
a first access platform positioned proximate the inlet and outlet control valves, wherein the inlet and outlet control valves are positioned for access from the first access platform at one or more ergonomically appropriate heights relative to an upper surface of the first access platform.

2. The system of claim 1, further comprising a second access platform that is positioned for access from the first access platform, wherein the filter vessel further comprises a removable portion that is positioned for access from the second access platform at one or more ergonomically appropriate heights relative to an upper surface of the second access platform.

3. The system of claim 2, wherein the removable portion of the filter vessel provides access to the removable filter insert.

4. The system of claim 2, wherein the upper surface of the first access platform is at a first height level and the upper surface of the second access platform is at a second height level that is different from the first height level.

5. The system of claim 1, further comprising:
a second filter vessel comprising a second removable filter insert;
a second inlet control valve providing selective fluid communication between the system inlet and the second filter vessel; and
a second outlet control valve providing selective fluid communication between the second filter vessel and the system outlet, wherein the second inlet and outlet control valves are positioned for access from the first access platform at one or more ergonomically appropriate second heights relative to the upper surface of the first access platform.

6. The system of claim 1, further comprising a base, wherein the base comprises at least one lift point for removing the removable filter insert from the filter vessel.

7. The system of claim 6, further comprising a lifting apparatus coupled to the at least one lifting point.

8. The system of claim 6, wherein the first access platform is coupled to the base.

9. The system of claim 8, wherein the first access platform is raised above the base.

10. A filter vessel, comprising:
a filter housing defining an inner bore, the filter housing comprising:
a flow inlet in the filter housing;
a flow outlet in the filter housing, wherein the flow inlet and flow outlet are in fluid communication with the inner bore; and
a removable portion providing access to the inner bore; and
a removable filter insert positioned in the inner bore, the removable filter insert comprising a seal that engages with and seals against an inner surface of the inner bore of the filter housing between the flow inlet and the flow outlet.

11. The filter vessel of claim 10, wherein the filter housing comprises a plurality of modular sections that are coupled together so as to define the inner bore.

12. The filter vessel of claim 10, wherein the inner bore of the filter housing is adapted to be substantially vertically oriented during operation of the filter vessel.

13. The filter vessel of claim 12, wherein a lower end of the removable filter insert is in contact with and supported by a lower end of the filter housing.

14. A flowback filter system, comprising:
a system inlet;
a system outlet;
a plurality of filter vessel;
a plurality of inlet control valves providing selective fluid communication between the system inlet and one or more of the plurality of filter vessels;
a plurality of outlet control valves providing selective fluid communication between the system outlet and one or more of the plurality of filter vessels;
at least one access platform positioned proximate the pluralities of inlet and outlet control valves and proximate the plurality of filter vessels, wherein each of the pluralities of inlet and outlet control valves and each of the plurality of filter vessels are positioned for access from the at least one access platform at one or more ergonomically appropriate heights relative to an upper surface of the at least one access platform.

15. The system of claim 14, wherein the at least one access platform comprises at least one first access platform and at least one second access platform, wherein at least one of the plurality of inlet and outlet control valves are positioned for access from the at least one first access platform at one or more ergonomically appropriate first heights relative to an upper surface of the at least one first access platform, and wherein at least one of the plurality of filter vessels are positioned for access from the at least one second access platform at one or more ergonomically appropriate second heights relative to an upper surface of the at least one second access platform.
